(19) United States
(12) Patent Application Publication
(10) Pub. No.: US 2014/0253598 A1
(43) Pub. Date: Sep. 11, 2014

(54) GENERATING SCALED IMAGES SIMULTANEOUSLY USING AN ORIGINAL IMAGE

(71) Applicants: MIN WOO SONG, Seoul (KR); Sung Chul Yoon, Hwaseong-si (KR); Jong Hyup Lee, Yongin-si (KR)

(72) Inventors: MIN WOO SONG, Seoul (KR); Sung Chul Yoon, Hwaseong-si (KR); Jong Hyup Lee, Yongin-si (KR)

(21) Appl. No.: 14/193,672

(22) Filed: Feb. 28, 2014

(30) Foreign Application Priority Data
Mar. 7, 2013 (KR) 10-2013-0024720

(51) Int. Cl. G06T 3/40

(52) U.S. Cl. CPC G06T 3/40
USPC 345/660

(57) ABSTRACT

A method of operating an image processing circuit includes receiving a first original image, and generating a plurality of first scaled images, each having a different resolution, based on the first original image. The plurality of first scaled images are generated in response to receiving the first original image one time.

### CROSS-REFERENCE TO RELATED APPLICATIONS

This application claims priority under 35 U.S.C. §119 to Korean Patent Application No. 10-2013-0024720, filed on Mar. 7, 2013, the disclosure of which is hereby incorporated by reference in its entirety.

### TECHNICAL FIELD

Exemplary embodiments of the present inventive concept relate to an image scaling technology, and more particularly, to a method for generating a plurality of scaled images having different resolutions at the same time using an original image, and devices performing the method.

### DISCUSSION OF THE RELATED ART

To convert an original image having a specific resolution into an image having a different resolution from the specific resolution, an operation that changes a resolution, for example, an image scaling operation, is performed.

To perform the image scaling operation, an image processing device including a scaler reads the original image from a memory device. Each time an image scaling operation is performed, the image processing device reads the original image from the memory device, which may increase a memory latency.

### SUMMARY

An exemplary embodiment of the present inventive concept is directed to a method of operating an image processing circuit, including receiving a first original image, and generating first scaled images each having a different resolution using the first original image.

The first scaled images may be generated at the same time.

The first scaled images may be generated by scaling the first original images using each of a plurality of scaling modules at the same time.

The method may further include receiving a second original image, generating second scaled images each having a different resolution, and generating a mixed image by mixing at least one of the first scaled images and at least one of the second scaled images.

An exemplary embodiment of the present inventive concept is directed to a system-on-chip (SoC), including a first buffer storing a first original image, and first scaling modules each differently scaling the first original image and generating first scaled images having different resolutions.

The SoC may further include a second buffer storing a second original image, second scaling modules each differently scaling the second original image and generating second scaled images having different resolutions, and a buffer mixing an image output from at least one of the first scaling modules and an image output from at least one of the second scaling modules and generating a mixed image.

The SoC may further include display controllers each transmitting at least one of the first scaled images to a corresponding display.

The SoC may further include a wireless LAN controller processing one of the first scaled images.

An exemplary embodiment of the present inventive concept is directed to an application processor including the SoC.

An exemplary embodiment of the present inventive concept is directed to a mobile device including a first memory device storing a first original image, and a SoC processing the first original image output from the first memory device. The SoC may include first scaling modules each differently scaling the first original image and generating first scaled images having different resolutions.

The SoC may further include a second buffer storing a second original image output from a second memory device, second scaling modules each differently scaling the second original image and generating second scaled images having different resolutions, and a buffer mixing an image output from at least one of the first scaling modules and an image output from at least one of the second scaling modules.

An exemplary embodiment of the present inventive concept is directed to a method of operating an image processing circuit, including receiving a first original image, and generating a plurality of first scaled images, each having a different resolution, based on the first original image. The plurality of first scaled images are generated in response to receiving the first original image one time.

An exemplary embodiment of the present inventive concept is directed to a SoC including a first buffer configured to store a first original image, and a plurality of first scaling modules configured to scale the first original image differently, and generate a plurality of first scaled images having different resolutions.

An exemplary embodiment of the present inventive concept is directed to a mobile device including a SoC. The SoC includes a first buffer configured to store a first original image output from a first memory device, and configured to process the first original image, and a plurality of first scaling modules configured to scale the first original image differently at substantially a same time, and generate a plurality of first scaled images having different resolutions.

An exemplary embodiment of the present inventive concept is directed to an image processing circuit including an input/output bus configured to receive a first original image from a first memory device, a direct memory access (DMA) controller configured to read the first original image from the first memory device via the input/output bus, a first buffer configured to store the first original image, a first scaler including a plurality of first scaling modules, wherein the plurality of first scaling modules are configured to scale the first original image differently, and generate a plurality of first scaled images having different resolutions, a plurality of display controllers, each configured to transmit one of the first scaled images from among the plurality of first scaled images to a corresponding display, and a central processing unit (CPU) configured to control an operation of the input/output bus, the DMA controller, the first buffer, the first scaler, and the plurality of display controllers.

An exemplary embodiment of the present inventive concept is directed to a display system including a first memory device, a first display, a second display, and an image processing circuit. The image processing circuit includes an input/output bus configured to receive a first original image from the first memory device, a direct memory access (DMA) controller configured to read the first original image from the first memory device via the input/output bus, a first buffer configured to store the first original image, a first scaler including a plurality of first scaling modules, wherein the plurality of first scaling modules are configured to scale the first original image differently, and generate a plurality of first scaled images having different resolutions, a plurality of display controllers, each configured to transmit one of the first scaled images from among the plurality of first scaled images to one of the first and second displays, and a CPU configured to control an operation of the input/output bus, the DMA controller, the first buffer, the first scaler, and the plurality of display controllers.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram of a display system, according to an exemplary embodiment of the present inventive concept.

FIG. 2 is a flowchart illustrating an operation of the display system of FIG. 1, according to an exemplary embodiment of the present inventive concept.

FIG. 3 is a block diagram of a display system, according to an exemplary embodiment of the present inventive concept.

FIG. 4 is a block diagram of a display system, according to an exemplary embodiment of the present inventive concept.

FIG. 5 is a flowchart illustrating an operation of the display system of FIG. 3 or FIG. 4, according to an exemplary embodiment of the present inventive concept.

### DETAILED DESCRIPTION OF THE EXEMPLARY EMBODIMENTS

Exemplary embodiments of the present inventive concept will be more fully described hereinafter with reference to the accompanying drawings. Like reference numerals may refer to like elements throughout the accompanying drawings.

It will be understood that when an element is referred to as being “connected” or “coupled” to another element, it can be directly connected or coupled to the other element or intervening elements may be present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

As used herein, the singular forms “a”, “an” and “the” may include the plural forms as well. It will be further understood that the terms “comprises” and/or “comprising,” or “includes” and/or “including” specify the presence of stated features, operations, elements, and/or components, but do not preclude the presence or addition of one or more other features operations, elements, components, and/or groups thereof.

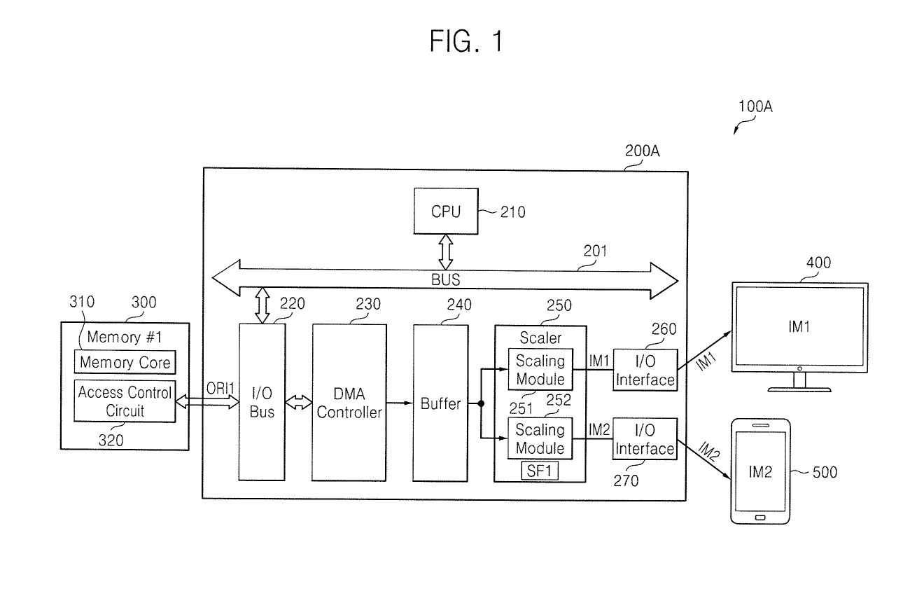

FIG. 1 is a block diagram of a display system, according to exemplary embodiments of the present inventive concept. Referring to FIG. 1, a display system 100A includes an image processing circuit 200A, a memory device 300, and one or more displays 400 and/or 500.

The display system 100A may be, for example, a personal computer (PC), a digital TV, an internet protocol (IP) TV, or a portable electronic device. However, the display system 100A is not limited thereto.

The portable electronic device, which may also referred to herein as a mobile device, may be, for example, a laptop computer, a mobile phone, a smartphone, a tablet PC, a personal digital assistant (PDA), an enterprise digital assistant (EDA), a digital still camera, a digital video camera, a portable multimedia player (PMP), a personal navigation device or portable navigation device (PND), a mobile internet device (MID), or an e-book. However, the portable electronic device is not limited thereto.

In an exemplary embodiment, the image processing circuit 200A receives a first original image ORI1 output from the memory device 300, and generates first scaled images IM1 and IM2. Each of the first scaled images IM1 and IM2 has a different resolution, and is generated using the received first original image ORI1.

The image processing circuit 200A may be, for example, a system-on-chip (SoC), and may be included as part of an application processor or as part of a mobile application processor.

The image processing circuit 200A may include a central processing unit (CPU), an input/output bus 220, a direct memory access (DMA) controller 230, a buffer 240, a scaler 250, a plurality of input/output interfaces 260 and 270, and a bus 201. Although the exemplary embodiment of FIG. 1 includes two input/output interfaces 260 and 270, the number of input/output interfaces in the image processing circuit 200A is not limited thereto.

The CPU 210 may control an operation of at least one of components 220, 230, 240, 250, 260, and 270. The CPU 210 and/or the DMA controller 230 may write an image to the memory device 300 or read an image from the memory device 300 through the input/output bus 220.

As used herein, an image may refer to two-dimensional (2D) image data or three-dimensional (3D) image data.

The DMA controller 230 reads the first original image ORI1 from the memory device 300 and writes the read original image ORI1 in the buffer 240 through the input/output bus 220.

The scaler 250, which performs an image scaling operation, includes a plurality of scaling modules 251 and 252. Although the exemplary embodiment of FIG. 1 includes two scaling modules 251 and 252, the number of scaling modules in the scaler 250 is not limited thereto.

Each of the plurality of scaling modules 251 and 252 in the scaler 250 scales the first original image ORI1 output from the buffer 240 at the same time, or substantially the same time, and generates first scaled images IM1 and IM2 according to a result of the scaling operation. As described above, the number of scaling modules in the scaler 250 is not limited to two. Thus, in exemplary embodiments in which the scaler 250 includes more than two scaling modules, more than two first scaled images may be generated by scaling the first original image ORI1 at each of the scaling modules at the same time, or substantially the same time. That is, the number of generated first scaled images may correspond to the number of scaling modules disposed in the scaler 250.

For example, in the exemplary embodiment of FIG. 1, the scaling module 252 may scale the first original image ORI1 while the scaling module 251 also scales the first original image ORI1.

Each of the plurality of scaling modules 251 and 252 may denote a hardware component which performs a scale-up algorithm and/or a scale-down algorithm. Information regarding an operation used for the scale-up or scale-down algorithm performed by each of the plurality of scaling modules 251 and 252 may be stored, for example, in a special function register SFR SF1 by the CPU 210. The respective resolutions of the first scaled images IM1 and IM2 are different from each other.

Each of the input/output interfaces 260 and 270 transmit one of the first scaled images IM1 and IM2 to one of the plurality of displays 400 and 500. Each of the input/output interfaces 260 and 270 may be, for example, an output DMA controller or a display controller. According to exemplary embodiments, at least one of the input/output interfaces 260 and 270 may be, for example, a wireless LAN controller that transmits a scaled image(s) to a display device wirelessly, the first scaled image IM1 may be, for example, a high-definition (HD) (e.g., full-HD) video, and the first scaled image IM2 may be, for example, a video graphic array (VGA) video.

When the display system 100A is a portable electronic device, the display 500 may be a part of the display system 100A, and the display 400 may be a display of a separate device such as, for example, a TV (e.g., a digital TV (DTV)).

When the display system 100A is a DTV, the display 400 may be a part of the display system 100A, and the display 500 may be a display of a separate device such as, for example, a portable electronic device.

The memory device 300 may include a memory core 310 (e.g., a memory array) storing the first original image ORI1, and an access control circuit 320 which may access the memory core 310.

The access control circuit 320 may perform a function of writing an image input through the input/output bus 220 in the memory core 310, and a function of reading an image from the memory core 310 and transmitting the read image to the input/output bus 220.

The displays 400 and 500 may have different resolutions and/or different sizes from each other. Each of the displays 400 and 500 may be, for example, a flat panel display such as a thin-film-transistor liquid crystal display (TFT LCD), a light emitting diode (LED) display, an organic LED (OLED), an active-matrix OLED (AMOLED), or a flexible display.

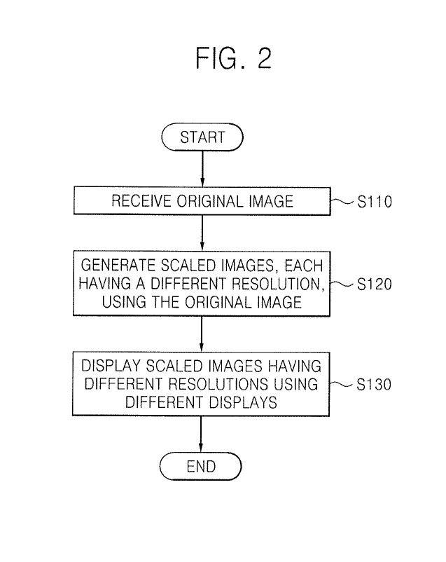

FIG. 2 is a flowchart illustrating an operation of the display system of FIG. 1, according to an exemplary embodiment of the present inventive concept.

Referring to FIGS. 1 and 2, an image processing circuit 200A receives the first original image ORI1 output from the memory device 300 at operation 5110.

Each of the plurality of scaling modules 251 and 252 scales the first original image ORI1 at the same time, or substantially the same time, using a different algorithm, and generates the first scaled images IM 1 and IM2, which have different resolutions from each other, at operation S120.

The image processing circuit 200A displays each of the first scaled images IM1 and IM2 using each of the plurality of displays 400 and 500 at operation S130.

As described above, the image processing circuit 200A may read the first original image ORI1 a single time, and generate scaled images, having different resolutions from each other, at the same time, or substantially the same time, based on reading the first original image ORI1 one time.

Thus, according to exemplary embodiments of the present inventive concept, the image processing circuit 200A may generate scaled images having different resolutions from each other by accessing the memory device 300 storing the first original image ORI1 a single time. That is, according to exemplary embodiments, the image processing circuit 200A is not required to access the memory device 300 a number of times equal to the number of scaled images being generated. As a result, a memory latency may be reduced.

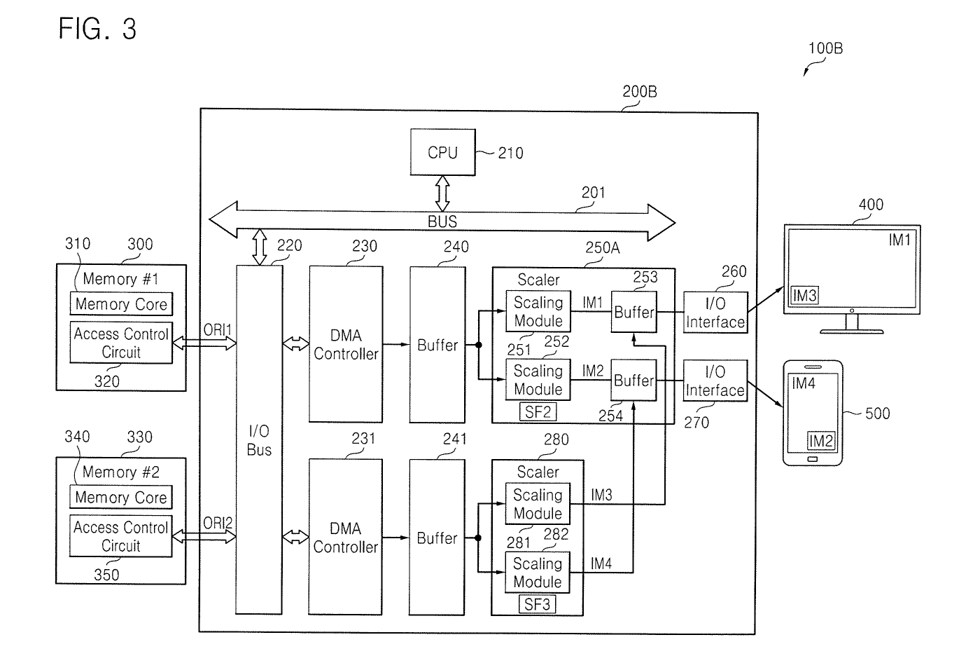

FIG. 3 is a block diagram of a display system, according to an exemplary embodiment of the present inventive concept. Referring to FIG. 3, a display system 100B includes an image processing circuit 200B, a first memory device 300, a second memory device 330, and one or more displays 400 and/or 500.

For convenience of explanation, referring to FIG. 3, a description of elements and operations similar to, or the same as those of the exemplary embodiment of FIG. 1 may be omitted.

The image processing circuit 200B receives the first original image ORI1 output from the first memory device 300, and generates first scaled images IM1 and IM2, each having a different resolution, using the received first original image ORI1. In addition, the image processing circuit 200B receives a second original image ORI2 output from the second memory device 330, and generates second scaled images IM3 and IM4, each having a different resolution, using the received second original image ORI2, which may be read from the second memory device 330 a single time.

The image processing circuit 200B may process, e.g., mix or merge, at least one of the first scaled images IM1 and IM2 and at least one of the second scaled images IM3 and IM4, and generate a processed, e.g., mixed or merged, image. Herein, the terms mix and merge may be used interchangeably.

The image processing circuit 200B may be, for example, a SoC, and may be a part of an application processor or a part of a mobile application processor.

The image processing circuit 200B includes a CPU 210, an input/output bus 220, a first DMA controller 230, a second DMA controller 231, a first buffer 240, a second buffer 241, a first scaler 250A, a second scaler 280, a plurality of input/output interfaces 260 and 270, and a bus 201.

The CPU 210 may control an operation of at least one of components 220, 230, 231, 240, 241, 250A, 280, 260, and 270.

The CPU 210, the first DMA controller 230, and/or the second DMA controller 231 may write an image in the memory devices 300 and 330 or read an image from the memory devices 300 and 330 through the input/output bus 220.

The first DMA controller 230 reads the first original image ORI1 from a first memory device 300 through the input/output bus 220 and writes the read original image ORI1 in the first buffer 240.

The second DMA controller 231 reads the second original image ORI2 from a second memory device 330 through the input/output bus 220 and writes the read original image ORI2 in the second buffer 241. Although the exemplary embodiment of FIG. 3 includes two separate buffers 240 and 241, exemplary embodiments are not limited thereto. For example, in an exemplary embodiment, the first buffer 240 and the second buffer 241 may be replaced with one buffer connected to the first and second DMA controllers 230 and 231, and the first and second scalers 250A and 280.

The first scaler 250A includes a plurality of scaling modules 251 and 252 and a plurality of buffers 253 and 254. The second scaler 280 includes a plurality of scaling modules 281 and 282. The plurality of buffers 253 and 254 may be referred to herein as mixing buffers.

Although the scalers 250A and 280 in the exemplary embodiment of FIG. 3 each include two scaling modules, the number of scaling modules in the scalers 250A and 280 is not limited thereto.

Each of the plurality of scaling modules 251 and 252 in the first scaler 250A scales the first original image ORI1 at the same time, or substantially the same time, and generates the first scaled images IM1 and IM2. Each of the first scaled images IM1 and IM2 has a different resolution.

Each of the plurality of scaling modules 281 and 282 in the second scaler 280 scales the second original image ORI2 at the same time, or substantially the same time, and generates the second scaled images IM3 and IM4. Each of the second scaled images IM3 and IM4 has a different resolution.

The CPU 210 may set or program information which may control an operation of each of the plurality of scaling modules 251 and 252 included in the first scaler 250A in the SFR SF2. In addition, the CPU 210 may set or program information which may control an operation of each of the plurality of scaling modules 281 and 282 included in the second scaler 280 in the SFR SF3.

The information may include, for example, information for selecting one of a plurality of scaling algorithms or information indicating a scaling ratio.

The buffer 253, which may perform a function of image mixing, may mix the scaled images IM1 and IM3 output from the scaling modules 251 and 281, and transmit a mixed image of IM1 and IM3 to a first input/output interface 260.

According to an exemplary embodiment, the buffer 253 may be replaced with an output module (e.g., an output DMA controller), which may transmit the mixed image to another function block such as, for example, a memory device.

The buffer 254, which may perform a function of image mixing, may mix the scaled images IM2 and IM4 output from the scaling modules 252 and 282, and transmit the mixed image of IM2 and IM4 to the second input/output interface 270.

According to an exemplary embodiment, the buffer 254 may be replaced with an output module (e.g., an output DMA controller), which may transmit the mixed image to another function block such as, for example, a memory device.

The first memory device 300 may include a memory core 310 (e.g., a memory array) storing the first original image ORI1, and an access control circuit 320 which may access the memory core 310. The second memory device 330 may include a memory 340 (e.g., a memory array 340) storing the second original image ORI2 and an access control circuit 350 which may access the memory core 340.

According to an exemplary embodiment, the number of buffers included in the first scaler 250A, and the number of images mixed by each of the buffers, may be varied.

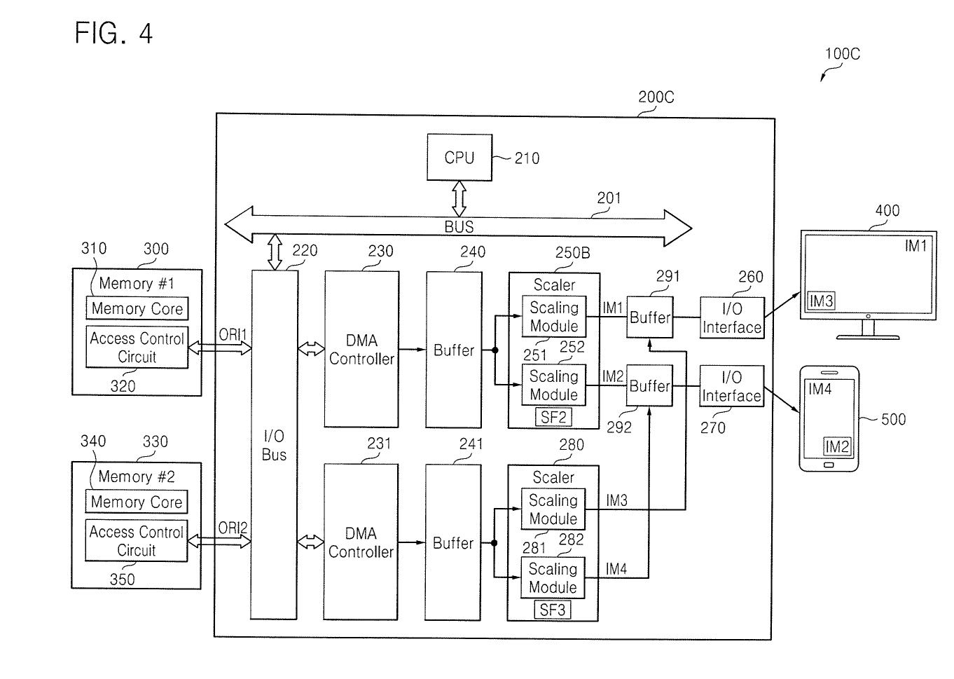

FIG. 4 is a block diagram of a display system, according to an exemplary embodiment of the present inventive concept. Except for the location of buffers 291 and 292, the operation and structure of the display system 100B including the image processing circuit 200B of FIG. 3 is substantially the same as the operation and structure of a display system 100C including an image processing circuit 200C of FIG. 4. For convenience of explanation, referring to FIG. 4, a description of elements and operations similar to, or the same as those of the exemplary embodiments of FIGS. 1 and 3 may be omitted. The plurality of buffers 291 and 292 may be referred to herein as mixing buffers.

In the exemplary embodiment of FIG. 3, the buffers 253 and 254 are disposed inside of the first scaler 250A. In the exemplary embodiment of FIG. 4, buffers 291 and 292 are disposed outside of the first scaler 250B. For example, the first scaler 250A may be embodied in a first intellectual property (IP) block, and the second scaler 280 may be embodied in a second IP block.

Each of the IP blocks described above is a function block used in the image processing circuit 200C when the image processing circuit 200C is a SoC, and may denote, for example, a CPU, a processor, each core of a multi-core processor, a codec, a Joint Photographic Experts Group (JPEG) processor, or a video processor.

Each of the buffers 291 and 292 may perform the function of image mixing, and may be replaced with the output module described with reference to FIG. 3.

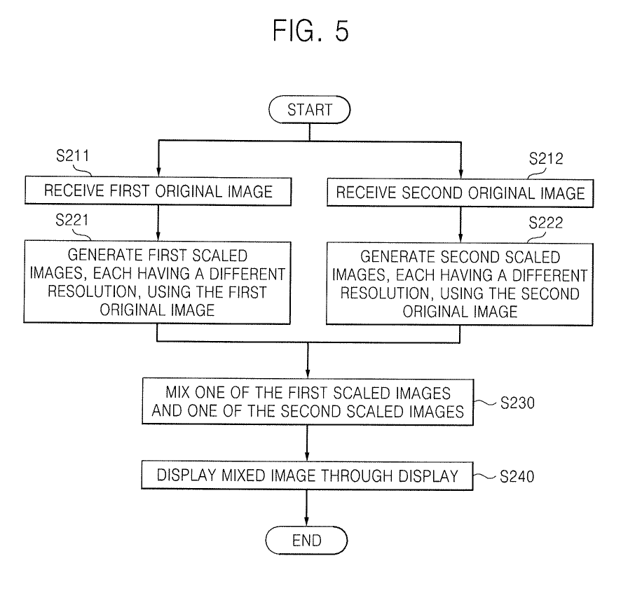

FIG. 5 is a flowchart illustrating an operation of the display system of FIG. 3 or FIG. 4, according to an exemplary embodiment of the present inventive concept. Referring to FIGS. 3 to 5, an image processing circuit 200B or 200C (collectively referred to herein as 200), receives the first original image ORI1 output from the first memory device 300 at operation 5211, and receives the second original image ORI2 output from the second memory device 330 at operation 5212. Operations 5211 and 5212 may be performed at the same time, substantially at the same time, or at different times.

Each of the plurality of scaling modules 251 and 252 of the image processing circuit 200 scales the first original image ORI1 using a different algorithm at the same time, or substantially the same time, and generates the first scaled images IM1 and IM2, each having a different resolution, at operation S221.

In addition, each of the plurality of scaling modules 281 and 282 of the image processing circuit 200 scales the second original image ORI2 using a different algorithm at the same time, or substantially the same time, and generates the second scaled images IM3 and IM4, each having a different resolution, at operation S222. Operations S221 and S222 may be performed at the same time, substantially the same time, or at different times.

The image processing circuit 200 mixes at least one of the first scaled images IM1 and IM2 and at least one of the second scaled images IM3 and IM4, and generates a mixed image at operation S230.

The image processing circuit 200 displays the mixed images IM 1 and IM3 through display 400, and displays the mixed images IM2 and IM4 through display 500 at operation S240.

According to exemplary embodiments of the present inventive concept, a method and a device may generate a plurality of scaled images, each having a different resolution, at the same time, or substantially the same time, using one original image, which may be read from memory once. Accordingly, the method and the device may reduce a memory latency, and may improve an image processing operation (e.g., scaling performance).

While the present inventive concept has been shown and described with reference to the exemplary embodiments thereof, it will be understood by those of ordinary skill in the art that various changes in form and detail may be made therein without departing from the spirit and scope of the present inventive concept, as defined by the following claims.

What is claimed is:

1. A method of operating an image processing circuit, comprising:
receiving a first original image; and
generating a plurality of first scaled images, each having a different resolution, based on the first original image,
wherein the plurality of first scaled images are generated in response to receiving the first original image one time.

2. The method of claim 1, wherein the plurality of first scaled images are generated at substantially a same time.

3. The method of claim 1, wherein generating the plurality of first scaled images comprises scaling the first original image by each of a plurality of scaling modules at substantially a same time.

4. The method of claim 1, further comprising:
receiving a second original image;
generating a plurality of second scaled images, each having a different resolution, based on the second original image; and
generating a mixed image by mixing at least one of the plurality of first scaled images and at least one of the plurality of second scaled images.

5. The method of claim 1, further comprising transmitting each of the plurality of first scaled images to a display controller from among a plurality of display controllers.

6. The method of claim 1, further comprising transmitting each of the plurality of first scaled images to a direct memory access (DMA) controller from among a plurality of DMA controllers.

7. A system-on-chip (SoC), comprising:
a first buffer configured to store a first original image; and
a plurality of first scaling modules configured to scale the first original image differently, and generate a plurality of first scaled images having different resolutions.

8. The SoC of claim 7, wherein each of the plurality of first scaling modules is configured to scale the first original image at substantially a same time.

9. The SoC of claim 7, further comprising a direct memory access (DMA) controller configured to read the first original image from a memory device, and store the read first original image in the first buffer.

10. The SoC of claim 7, further comprising:
a second buffer configured to store a second original image;
a plurality of second scaling modules configured to scale the second original image differently, and generate a plurality of second scaled images having different resolutions; and
a mixing buffer configured to generate a mixed image by mixing at least one of the plurality of first scaled images and at least one of the plurality of second scaled images.

11. The SoC of claim 7, further comprising a plurality of display controllers, each configured to transmit a first scaled image from among the plurality of first scaled images to a corresponding display.

12. The SoC of claim 7, further comprising a wireless LAN controller configured to process one of the plurality of first scaled images.

13. An application processor comprising the SoC of claim 7.

14. The application processor of claim 13, wherein the SoC further comprises:
a second buffer configured to store a second original image;
a plurality of second scaling modules configured to scale the second original image differently, and generate a plurality of second scaled images having different resolutions; and
a mixing buffer configured to generate a mixed image by mixing at least one of the plurality of first scaled images and at least one of the plurality of second scaled images.

15. A mobile device, comprising:
a system-on-chip (SoC), comprising:
a first buffer configured to store a first original image output from a first memory device, and configured to process the first original image; and
a plurality of first scaling modules configured to scale the first original image differently at substantially a same time, and generate a plurality of first scaled images having different resolutions.

16. The mobile device of claim 15, further comprising a display device, wherein the SoC further comprises:
a first display controller configured to transmit one of the plurality of first scaled images to the display device; and
a second display controller configured to transmit another one of the plurality of first scaled images to another display device located externally from the mobile device.

17. The mobile device of claim 15, wherein the SoC further comprises:
a second buffer configured to store a second original image output from a second memory device;
a plurality of second scaling modules configured to scale the second original image differently at substantially a same time, and generate a plurality of second scaled images having different resolutions; and
a mixing buffer configured to generate a mixed image by mixing at least one of the plurality of first scaled images and at least one of the plurality of second scaled images.

18. The mobile device of claim 17, further comprising a display device, wherein the SoC further comprises:
a first display controller configured to transmit one of the plurality of first scaled images to the display device; and
a second display controller configured to transmit another one of the plurality of first scaled images to another display device located externally from the mobile device.

19. The mobile device of claim 17, further comprising a display device, wherein the SoC further comprises:
a display controller configured to transmit one of the plurality of first scaled images to the display device; and
a wireless LAN controller configured to wirelessly transmit another one of the plurality of first scaled images to another display device located externally from the mobile device.

20. An image processing circuit, comprising:
an input/output bus configured to receive a first original image from a first memory device;
a direct memory access (DMA) controller configured to read the first original image from the first memory device via the input/output bus;
a first buffer configured to store the first original image;
a first scaler comprising a plurality of first scaling modules, wherein the plurality of first scaling modules are configured to scale the first original image differently, and generate a plurality of first scaled images having different resolutions;
a plurality of display controllers, each configured to transmit one of the first scaled images from among the plurality of first scaled images to a corresponding display; and
a central processing unit (CPU) configured to control an operation of the input/output bus, the DMA controller, the first buffer, the first scaler, and the plurality of display controllers.

21. The image processing circuit of claim 20, further comprising:
a second DMA controller configured to read a second original image from a second memory device via the input/output bus;
a second buffer configured to store the second original image;
a second scaler comprising a plurality of second scaling modules, wherein the plurality of second scaling modules are configured to scale the second original image differently, and generate a plurality of second scaled images having different resolutions; and
a plurality of mixing buffers, each configured to generate a mixed image by mixing at least one of the plurality of first scaled images and at least one of the plurality of second scaled images,
wherein the plurality of display controllers are each configured to transmit one of the mixed images to the corresponding display,
wherein the CPU is configured to control an operation of the second DMA controller, the second buffer, the second scaler, and the plurality of mixing buffers.

22. The image processing circuit of claim 21, wherein the image processing circuit is a system-on-chip (SoC).

23. The image processing circuit of claim 22, wherein the SoC is disposed in a mobile device.

24. The image processing circuit of claim 21, wherein the plurality of mixing buffers are disposed inside of the first scaler.

25. The image processing circuit of claim 21, wherein the plurality of mixing buffers are disposed outside of the first scaler.

26. A display system, comprising:
a first memory device;
a first display;
a second display; and
an image processing circuit, comprising:
an input/output bus configured to receive a first original image from the first memory device;
a direct memory access (DMA) controller configured to read the first original image from the first memory device via the input/output bus;
a first buffer configured to store the first original image;
a first scaler comprising a plurality of first scaling modules, wherein the plurality of first scaling modules are configured to scale the first original image differently, and generate a plurality of first scaled images having different resolutions;
a plurality of display controllers, each configured to transmit one of the first scaled images from among the plurality of first scaled images to one of the first and second displays; and
a central processing unit (CPU) configured to control an operation of the input/output bus, the DMA controller, the first buffer, the first scaler, and the plurality of display controllers.

27. The display system of claim 26, wherein the display system further comprises a second memory device, and the image processing circuit further comprises:
a second DMA controller configured to read a second original image from the second memory device via the input/output bus;
a second buffer configured to store the second original image;
a second scaler comprising a plurality of second scaling modules, wherein the plurality of second scaling modules are configured to scale the second original image differently, and generate a plurality of second scaled images having different resolutions; and
a plurality of mixing buffers, each configured to generate a mixed image by mixing at least one of the plurality of first scaled images and at least one of the plurality of second scaled images,
wherein the plurality of display controllers are each configured to transmit one of the mixed images to one of the first and second displays,
wherein the CPU is configured to control an operation of the second DMA controller, the second buffer, the second scaler, and the plurality of mixing buffers.

28. The display system of claim 27, wherein the image processing circuit is a system-on-chip (SoC).

29. The display system of claim 28, wherein the SoC is disposed in a mobile device.

30. The display system of claim 27, wherein the plurality of mixing buffers are disposed inside of the first scaler.
